(19) United States
(12) Patent Application Publication
(10) Pub. No.: US 2018/0368134 A1
(43) Pub. Date: Dec. 20, 2018

(54) METHOD FOR PROCESSING CAPABILITY INFORMATION OF USER EQUIPMENT, USER EQUIPMENT, AND BASE STATION

(71) Applicant: HUAWEI TECHNOLOGIES CO., LTD., Shenzhen (CN)

(72) Inventors: Jian ZHANG, Shenzhen (CN); Qinghai ZENG, Shanghai (CN)

(21) Appl. No.: 16/119,431

(22) Filed: Aug. 31, 2018

Related U.S. Application Data
(63) Continuation of application No. PCT/CN2017/075415, filed on Mar. 2, 2017.

(30) Foreign Application Priority Data
Mar. 4, 2016 (CN) 201610124487.3

(51) Int. Cl. H04W 72/04; H04W 72/12

(52) U.S. Cl. CPC H04W 72/048; H04W 72/0446; H04W 72/1215

(57) ABSTRACT

Embodiments described in this application resolves a problem of processing air interface capability information of a user equipment (UE), so that the UE may support a plurality of different air interface types on a same carrier, and therefore the base station may flexibly allocate a resource to the UE between a plurality of air interface types more flexibly based on the capability information of the UE, to more flexibly adapt to the dynamic requirements of the service and the radio condition.

### CROSS-REFERENCE TO RELATED APPLICATIONS

This application is a continuation of International Application No. PCT/CN2017/075415, filed on Mar. 2, 2017, which claims priority to Chinese Patent Application No. 201610124487.3, filed on Mar. 4, 2016. The disclosures of the aforementioned applications are hereby incorporated by reference in their entireties.

### TECHNICAL FIELD

This application relates to the communications field, and in particular, to a method for processing capability information of user equipment, user equipment, and a base station in the communications field.

### BACKGROUND

An air interface (“AI” for short) technology is also referred to as a radio interface technology (“RIT” for short), and radio interface protocols (“RIP” for short) used in the air interface technology usually include aspects such as a multiple access (“MA” for short) manner, a modulation and coding scheme (“MCS” for short), a frame structure (“FS” for short), a physical channel (“PC” for short), a transport channel (TC″ for short), a logical channel (“LC” for short), Media Access Control (“MAC” for short), Radio Link Control (“RLC” for short), Packet Data Convergence Protocol (“PDCP” for short), and Radio Resource Control (“RRC” for short). To support different services whose quality of service (“QoS” for short) requirements or radio condition requirements are greatly different on a same carrier, use of a frequency division manner can provide more flexible and efficient radio resource utilization, and can dynamically adjust occupancy of these services for radio resources more flexibly based on requirements of different services on bandwidth. However, a conventional wireless communications system supports only one radio interface technology on one carrier. When different radio interface technologies are needed to better support QoS requirements of different services and better adapt to a change in a radio condition of a user, different carriers need to be used, or radio resources on a same carrier need to be used in a time division manner. A radio resource use manner is inflexible, and consequently it is difficult to perform dynamic adjustment based on a status of requirements of different services on the radio resources.

### SUMMARY

In view of this, embodiments of this application provide a method for processing capability information of user equipment, to resolve a problem that a radio resource use manner cannot flexibly adapt to dynamic requirements of a service and a radio condition.

According to a first aspect, a method for processing capability information of user equipment (UE) is provided. The method includes:

determining, by the UE, at least two of a plurality of air interface types supported by a same carrier as target air interface types; and

sending, by the UE, air interface indication information to a base station based on the target air interface types, so that the base station schedules the UE based on the air interface indication information.

The scheduling, by the base station, the UE may include flexibly allocating, by the base station, a radio resource to the UE between a plurality of air interfaces.

Therefore, the method described in this application resolves a problem that a radio resource use manner cannot flexibly adapt to dynamic requirements of a service and a radio condition, so that the UE can support a plurality of different air interface types on a same carrier, to more flexibly adapt to the dynamic requirements of the service and the radio condition.

In one embodiment, the air interface indication information includes target capability information corresponding to the target air interface types, and the target capability information includes at least two pieces of capability information in a one-to-one correspondence with the at least two air interface types, and before the sending, by the UE, air interface indication information to a base station, the method further includes:

determining, by the UE, the target capability information.

In this way, the UE independently determines the target capability information, so that the base station may flexibly allocate a resource to the UE between a plurality of air interface types more flexibly based on the target capability information of the UE, to more flexibly adapt to the dynamic requirements of the service and the radio condition.

In an embodiment, the determining, by the UE, target capability information corresponding to the target air interface types includes:

determining, by the UE, the target capability information based on a maximum quantity of air interface types that the UE is capable of simultaneously configuring or simultaneously running and a total capability information value of the UE, where a quantity of the target air interface types is less than or equal to the maximum quantity of air interface types that the UE is capable of simultaneously configuring or simultaneously running.

The total capability information value of the UE is a sum of capability information corresponding to all of the air interface types that the UE can simultaneously configure or run, and the sum of the capability information may indicate a maximum capability information value that the UE can support, for example, a maximum bandwidth that the UE can provide to these air interface types, a maximum spatial multiplexing layer quantity that the UE can support, or a maximum transmit power that the UE can have.

It should be noted that, the sum of the capability information corresponding to all of the air interface types supported by the UE may exceed the total capability information value of the UE, but a sum of capability information corresponding to all of air interface types that the UE simultaneously configures or simultaneously runs within a transmission time interval (TTI) cannot exceed the total capability information value of the UE. When the UE configures or runs only one air interface type, the air interface type exclusively occupies the total capability information value.

In one embodiment, the determining, by the UE, the target capability information corresponding to the target air interface types based on a maximum quantity of air interface types that the UE simultaneously configures or simultaneously runs and a total capability information value of the UE includes:

averagely allocating, by the UE, the total capability information value based on the maximum quantity of air interface types that the UE is capable of simultaneously configuring or simultaneously running, and determining a capability information value obtained after the average allocation as the target capability information corresponding to the target air interface types.

In another embodiment, the determining, by the UE, the target capability information based on a maximum quantity of air interface types that the UE is capable of simultaneously configuring or simultaneously running and a total capability information value of the UE includes:

determining, by the UE, the target capability information based on the maximum quantity of air interface types that the UE is capable of simultaneously configuring or simultaneously running, the total capability information value of the UE, and at least one of the following information:

adaptive change information of the target air interface types, radio resources occupied by the target air interface types within each TTI, and capability requirement values of the target air interface types, where the adaptive change information is used to indicate whether the target air interface types support a dynamic capability information configuration and/or a semi-static capability information configuration.

In one embodiment, the air interface indication information includes indication information used to indicate the target air interface types determined by the UE, and the method further includes:

sending, by the UE, capability indication information to the base station, where the capability indication information includes a maximum quantity of air interface types that the UE is capable of simultaneously configuring or simultaneously running, and a total capability information value of the UE.

In one embodiment, the UE may flexibly adjust the capability information corresponding to the target air interface types based on a quantity of target air interface types determined each time and the total capability information value of the UE when the target air interface types are changed.

In one embodiment, before the UE determines the target air interface types and the capability information corresponding to the target air interface types, the method may further include: categorizing, based on the capability information, air interface types supported by the UE. For example, air interface types supporting an orthogonal frequency division multiple access technology are used as a category, and air interface types supporting a sparse code multiple access technology are used as a category. Therefore, it is convenient for the UE to search for and determine a target air interface type.

In one embodiment, the target air interface types sent by the UE to the base station may be sent based on an indication of the base station. For example, the base station may be designated to obtain capability information corresponding to a first air interface type and a second air interface type that are supported by the UE, or obtain capability information corresponding to all air interface types supported by the UE.

According to a second aspect, a method for processing capability information of user equipment UE is provided. The method includes:

receiving, by the base station, air interface type indication information sent by the UE, where the air interface indication information is determined by the UE based on target air interface types, and the target air interface types include at least two air interface types supported by the UE on a same carrier; and scheduling, by the base station, the UE based on the air interface indication information.

The scheduling, by the base station, the UE may include flexibly allocating, by the base station, a radio resource to the UE between a plurality of air interfaces.

Therefore, the method described in this application resolves a problem that a radio resource use manner cannot flexibly adapt to dynamic requirements of a service and a radio condition, so that the UE can support a plurality of different air interface types on a same carrier, to more flexibly adapt to the dynamic requirements of the service and the radio condition.

In one embodiment, the air interface indication information includes indication information used to indicate the target air interface types determined by the UE, where the scheduling, by the base station, the UE based on the air interface indication information includes:

determining, by the base station, target capability information corresponding to the target air interface types, where the target capability information is at least two pieces of capability information in a one-to-one correspondence with the at least two air interface types; and scheduling, by the base station, the UE based on the target capability information.

In this way, by processing the air interface capability information of the UE, the base station may flexibly allocate a resource to the UE between a plurality of air interface types more flexibly based on the capability information of the UE, to more flexibly adapt to the dynamic requirements of the service and the radio condition.

In an embodiment, the method further includes:

receiving, by the base station, capability indication information sent by the UE, where the capability indication information includes a maximum quantity of air interface types that the UE is capable of simultaneously configuring or simultaneously running, and a total capability information value of the UE, where the determining, by the base station, target capability information corresponding to the target air interface types includes:

determining, by the base station, the target capability information corresponding to the target air interface types based on a maximum quantity of air interface types that the UE is capable of simultaneously configuring or simultaneously running and a total capability information value of the UE, where a quantity of the target air interface types is less than or equal to the maximum quantity of air interface types that the UE is capable of simultaneously configuring or simultaneously running.

The total capability information value of the UE is a sum of capability information corresponding to all of the air interface types that the UE can simultaneously configure or run, and the sum of the capability information may indicate a maximum capability information value that the UE can support, for example, a maximum bandwidth that the UE can provide to these air interface types, a maximum spatial multiplexing layer quantity that the UE can support, or a maximum transmit power that the UE can have.

In one embodiment, the determining, by the base station, the target capability information corresponding to the target air interface types based on a maximum quantity of air interface types that the UE is capable of simultaneously configuring or simultaneously running and a total capability information value of the UE includes:

averagely allocating, by the base station, the total capability information value based on the maximum quantity of air interface types that the UE is capable of simultaneously configuring or simultaneously running, and determining a capability information value obtained after the average allocation as the target capability information corresponding to the target air interface types.

In another embodiment, the determining, by the base station, the target capability information corresponding to the target air interface types based on a maximum quantity of air interface types that the UE is capable of simultaneously configuring or simultaneously running and a total capability information value of the UE includes:

determining, by the base station, the target capability information corresponding to the target air interface types based on the maximum quantity of air interface types that the UE is capable of simultaneously configuring or simultaneously running, the total capability information value of the UE, and at least one of the following information:

adaptive change information of the target air interface types, radio resources occupied by the target air interface types within each transmission time interval TTI, and capability requirement values of the target air interface types, where the adaptive change information is used to indicate whether the target air interface types support a dynamic capability information configuration and/or a semi-static capability information configuration.

In one embodiment, the air interface indication information includes target capability information corresponding to the target air interface types determined by the UE, and the target capability information is at least two pieces of capability information in a one-to-one correspondence with the at least two air interface types.

In an embodiment, after the base station receives the target capability information sent by the UE, the method further includes: sending, by the base station, the target capability information corresponding to the target air interface types to at least two mobility management entities (MME), so that the at least two MMEs store the target capability information corresponding to the target air interface types, where the at least two MMEs are in a one-to-one correspondence with the at least two air interface types.

In one embodiment, the method further includes: sending, by the base station, a capability query message to the at least two MMEs; and receiving, by the base station, the target capability information that corresponds to the target air interface types and that is sent by the at least two MMEs based on the capability query message.

In this way, the base station sends the determined target capability information to an MME for storage, so that the base station may obtain the target capability information from the MME or the UE based on a network status, thereby flexibly allocating a resource to the UE between a plurality of air interface types, and improving efficiency of scheduling the UE by the base station.

The capability information described in this application can include at least one of the following: a total quantity of uplink or downlink transport block bits within each TTI, a quantity of uplink or downlink spatial multiplexing layers of the UE, a quantity of soft channel bits of the UE within each TTI, a maximum modulation order supported by the UE, a total layer 2 buffer size of the UE, a physical layer parameter, a radio frequency parameter, and a maximum transmit power of the UE.

Additionally, the air interface type described in this application may be determined based on at least one of the following parameters: a multiple access manner, a frame structure, a cyclic prefix length, a hybrid automatic repeat request round trip time, a subcarrier width, a physical channel, an uplink subframe configuration, a downlink subframe configuration, and the like. That is, the air interface type may be indicated by a combination of the foregoing parameters, and different air interface types are different in at least one of the foregoing parameters.

According to a third aspect, user equipment is provided, configured to perform the method based on the first aspect or any possible implementation of the first aspect. The user equipment includes:

a determining module, configured to determine at least two of a plurality of air interface types supported by a same carrier as target air interface types; and

a sending module, configured to send air interface indication information to a base station based on the target air interface types determined by the determining module, so that the base station schedules the UE based on the air interface indication information.

According to a fourth aspect, a base station is provided, configured to perform the method according to the second aspect or any possible implementation of the second aspect. The base station includes:

a receiving module, configured to receive air interface indication information sent by the UE, where the air interface indication information is determined by the UE based on target air interface types, and the target air interface types include at least two of a plurality of air interface types supported by the UE on a same carrier; and a scheduling module, configured to schedule the UE based on the air interface indication information received by the receiving module.

According to a fifth aspect, user equipment is provided. The user equipment includes a processor, a memory, a receiver, and a transmitter. The transmitter and the receiver are respectively configured to send and receive information in a communication process, the memory is configured to store an instruction, the processor is configured to execute the instruction stored in the memory, and the execution on the instruction stored in the memory causes the processor to perform the method according to the first aspect or any possible implementation of the first aspect. In one embodiment, the processor is configured to:

determine at least two of a plurality of air interface types supported by a same carrier as target air interface types; and

the transmitter is configured to send air interface indication information to a base station based on the target air interface types, so that the base station schedules the UE based on the air interface indication information.

According to a sixth aspect, a base station is provided. The base station includes a processor, a memory, a receiver, and a transmitter. The transmitter and the receiver are respectively configured to send and receive information in a communication process, the memory is configured to store an instruction, the processor is configured to execute the instruction stored in the memory, and the execution on the instruction stored in the memory causes the processor to perform the method according to the first aspect or any possible implementation of the first aspect. In one embodiment, the receiver is specifically configured to:

receive air interface indication information sent by the UE, where the air interface indication information is determined by the UE based on target air interface types, and the target air interface types include at least two of a plurality of air interface types supported by the UE on a same carrier; and the processor is configured to schedule the UE based on the air interface indication information.

According to a seventh aspect, a communications system is provided. The communications system includes the user equipment according to the third aspect and the base station according to the fourth aspect.

According to an eighth aspect, a communications system is provided. The communications system includes the base station according to the fourth aspect.

According to a ninth aspect, a system chip is provided. The system chip includes an input interface, an output interface, at least one processor, and a memory. The input interface, the output interface, the processor, and the memory communicate with each other by using an internal connection path, so as to transmit a control signal and/or data, the processor is configured to execute code in the memory, and when the code is executed, the processor implements the method in the first aspect.

According to a tenth aspect, a system chip is provided. The system chip includes an input interface, an output interface, at least one processor, and a memory. The input interface, the output interface, the processor, and the memory communicate with each other by using an internal connection path, so as to transmit a control signal and/or data, the processor is configured to execute code in the memory, and when the code is executed, the processor invokes the input interface and the output interface to implement the method in the second aspect.

According to an eleventh aspect, a computer readable medium is provided. The computer readable medium is configured to store a computer program. The computer program includes an instruction used to perform the method according to any one of the first aspect or the possible implementations of the first aspect.

According to a twelfth aspect, a computer readable medium is provided. The computer readable medium is configured to store a computer program. The computer program includes an instruction used to perform the method according to any one of the second aspect or the possible implementations of the second aspect.

Based on the foregoing technical solutions, the method for processing capability information of user equipment in the embodiments of this application resolves the problem that a radio resource use manner cannot flexibly adapt to dynamic requirements of a service and a radio condition. The air interface capability information of the UE is processed, so that the UE may support a plurality of different air interface types on a same carrier, and therefore the base station may flexibly allocate a resource to the UE between a plurality of air interface types more flexibly based on the capability information of the UE, to more flexibly adapt to the dynamic requirements of the service and the radio condition.

### BRIEF DESCRIPTION OF DRAWINGS

FIG. 1 is a schematic diagram of an application scenario according to an embodiment of this application;

FIG. 2 is an adaptive flowchart of a method for processing capability information of user equipment according to an embodiment of this application;

FIG. 3 is an adaptive flowchart of a method for processing capability information of user equipment according to another embodiment of this application;

FIG. 4 is a process interaction diagram of a method for processing capability information of user equipment according to an embodiment of this application;

FIG. 5 is a process interaction diagram of a method for processing capability information of user equipment according to another embodiment of this application;

FIG. 6 is a schematic structural block diagram of user equipment according to an embodiment of this application;

FIG. 7 is a schematic structural block diagram of a base station according to an embodiment of this application;

FIG. 8 is a schematic structural block diagram of user equipment according to an embodiment of this application;

FIG. 9 is a schematic structural block diagram of a base station according to an embodiment of this application;

FIG. 10 is a schematic structural diagram of a communications system according to an embodiment of this application;

FIG. 11 is a schematic structural diagram of a communications system according to another embodiment of this application;

FIG. 12 is a schematic structural diagram of a system chip according to an embodiment of this application; and

FIG. 13 is a schematic structural diagram of a system chip according to another embodiment of this application.

### DESCRIPTION OF EMBODIMENTS

It should be understood that, the technical solutions of the embodiments of this application may be applied to various communications systems, such as: a Global System of Mobile Communications (“GSM” for short) system, a Code Division Multiple Access (“CDMA” for short) system, a Wideband Code Division Multiple Access (“WCDMA” for short) system, a general packet radio service (“GPRS” for short), a Long Term Evolution (“LTE” for short) system, an LTE frequency division duplex (“FDD” for short) system, an LTE time division duplex (“TDD” for short), a Universal Mobile Telecommunications System (“UMTS” for short), a Worldwide Interoperability for Microwave Access (“WiMAX” for short), a wireless local area network (“WLAN” for short) communications system, a future fifth generation (5G) wireless communications system, or the like. The embodiments of this application are described by using an LTE communications system as an example.

It should also be understood that in the embodiments of this application, user equipment (UE for short) may be referred to as a terminal, a mobile station (MS for short), a mobile terminal, and the like. The user equipment may communicate with one or more core networks through a radio access network (RAN for short). For example, the user equipment may be a mobile phone (also referred to as a “cellular” phone) or a computer with a mobile terminal. For example, the user equipment may also be a portable, pocket-sized, handheld, computer built-in, or in-vehicle mobile apparatus, which exchanges voice and/or data with the radio access network.

In the embodiments of this application, a base station may be a base station (BTS for short) in GSM or CDMA, or may be a base station (NodeB, NB for short) in WCDMA, or may be an evolved NodeB (Evolved Node B, “eNB” or “e-NodeB” for short) in LTE. This is not limited in this application. However, for ease of description, the following embodiments are described by using an eNB as an example.

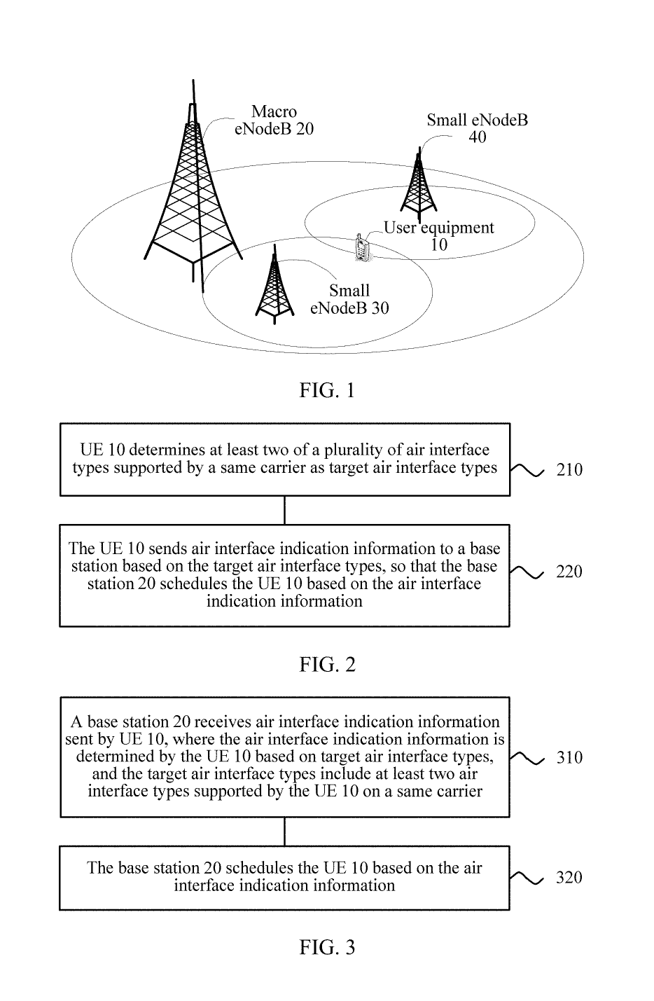

FIG. 1 is a schematic diagram of an application scenario according to an embodiment of this application. As shown in FIG. 1, a basic network architecture of an LTE communications system may include, for example, UE 10, a macro eNodeB 20, a small eNodeB 30, and a small eNodeB 40. The UE 10 is located within coverage of one or more cells (that may be understood as carriers) provided by the macro eNodeB 20, the small eNodeB 30, or the small eNodeB 40, and one or more cells may serve the UE 10. When a plurality of cells serve the UE 10, the UE 10 may operate in a manner such as carrier aggregation (“CA” for short), dual connectivity (“DC” for short), or coordinated multipoint transmission (“CoMP” for short), where a carrier in CA is provided by at least one base station, at least one cell provides at least one air interface technology AI, and one or more AIs in the at least one air interface technology may be configured for the UE 10. This embodiment of this application is described by using an example in which three AIs are provided to the UE 10 within one cell. It should be understood that, a method described in this embodiment of this application is also applicable to a case in which two or more than three Ms are provided to the UE 10 within one cell.

Based on the application scenario of this embodiment of this application described in FIG. 1, a plurality of radio interfaces AI are provided to the UE 10 on a same carrier, different AIs occupy different frequency ranges on the carrier in a frequency division manner, or occupy a same frequency range on the carrier in a time division manner, or the foregoing two manners are combined. For example, there is an overlapping area on a frequency range, but time division is performed in the overlapping area. This is not limited in the method described in this embodiment of this application.

In general, because a plurality of different air interface technologies cannot be all supported on a same carrier, only a time division method can be used, or different carriers are used to support different radio interface technologies. A same radio interface technology on a carrier supports services of various quality of service, for example, supports a guaranteed bit rate (Guaranteed Bit Rate, “GBR” for short) service and a non-guaranteed bit rate service (Non-GBR). A same radio interface may be used on a same carrier to support both a mobile broadband (Mobile Broad Band, “MBB” for short) service and a machine to machine communication (Machine to Machine, “M2M” for short) service. Some optimized solutions may be used for M2M communication. For example, an extended access barring (Extended Access Barring, “EAB” for short) mechanism is introduced in an M2M service tolerating a delay, so that some M2M terminals are temporarily prevented from access during network congestion or overload.

For another example, for such a special service as multimedia broadcast multicast service (Multimedia Broadcast Multicast Service, “MBMS” for short), if a conventional wireless communications system needs to support both an MBMS service and support a normal unicast (Unicast) service in a time division manner on a same carrier, only a time division method can be used, or different carriers are used to support different radio interface technologies. For example, in an LTE system, some dedicated multimedia broadcast multicast single frequency network (Multimedia Broadcast Multicast Single Frequency Network, “MBMSFN” for short) subframes are configured for an MBMS service on a same carrier, and remaining subframes are used to receive LTE system information, service information, and the like. An LTE frame format used by a subframe occupied by a unicast service and that used by a subframe occupied by an MBMS service are slightly different in parameters. For example, a cyclic prefix (CP) length of an orthogonal frequency division multiplexing (Orthogonal Frequency Division Multiplexing, “OFDM” for short) symbol of an MBMS subframe is greater than a CP length of a unicast service subframe, to resolve an inter-symbol interference (“ISI” for short) problem caused by a larger delay spread of a multi-cell single frequency network transmission manner of the MBMS service.

However, if different services, whose QoS requirements and/or radio condition requirements differ greatly, need to be supported on a same carrier, use of a frequency division manner can provide more flexible and efficient radio resource utilization, and dynamic adjustments of occupancy of these services for radio resources can be made more flexible based on bandwidth requirements of the different services. For example, for a scenario in which an M2M service having an ultra-low delay requirement (for example, a delay requirement is less than 1 ms) and a unicast service coexist on a same carrier, the M2M service and the mobile broadband (MBB, mobile broadband) unicast service may use different radio interface technologies. For example, multiple access manners, frame formats, physical layer parameters, and even physical channels may be set differently. In general, an MBMS service and a unicast service to use a radio resource in a frequency division manner on a same carrier is not supported. Therefore, the method described in this embodiment of this application is introduced, to support different radio interface technologies in a frequency division manner on a same carrier, thereby dynamically adjusting radio resource allocation more flexibly based on a status of requirements of different services on radio resources and improving radio resource utilization.

To support a flexible air interface carrier, the UE 10 needs a corresponding flexible air interface support capability. Therefore, a problem of processing capability information of the UE 10 for a flexible air interface needs to be resolved. The flexible air interface carrier may also provide support for conventional user equipment, for example, by providing a backward compatible frequency range. For the conventional user equipment, capability information of the user equipment may be processed based on a conventional method that processes capability information.

The capability information of the user equipment is used to represent a capability of a terminal, and the capability includes two parts: One part is radio capability information (Radio Capability Information) of the user equipment, and the other part is network capability information (Network Capability Information). The radio capability information of the UE 10 includes a status of a radio access technology supported by the UE 10, for example, a power class (Power Class) of the UE 10 and a frequency band supported by the UE 10. The network capability information of the UE 10 is capability information that is unrelated to radio capability information such as a non-access stratum (“NAS” for short) encryption algorithm supporting status of the UE 10. Capability sets of the UE 10 are graded because hardware designs of different user equipments are different from each other and signal processing capabilities are different.

When the UE 10 establishes a Radio Resource Control (Radio Resource Control, “RRC” for short) connection to the base station 20, the UE 10 needs to report radio access capability (Radio Access Capability) information of the UE 10 to a network, and the base station 20 needs to schedule the UE 10 based on the radio access capability of the UE 10. The base station 20 may obtain the capability information from a mobility management entity (Mobility Management Entity, “MME” for short) or the UE 10.

FIG. 2 is an adaptive flowchart of a method for processing capability information of user equipment according to an embodiment of this application. The method for processing capability information of user equipment shown in FIG. 2 is performed by UE 10, and includes the following operations.

Operation 210. The UE 10 determines at least two of a plurality of air interface types supported by a same carrier as target air interface types.

Operation 220. The UE 10 sends air interface indication information to a base station based on the target air interface types, so that the base station 20 schedules the UE 10 based on the air interface indication information.

FIG. 3 is an adaptive flowchart of a method for processing capability information of user equipment according to another embodiment of this application. The method for processing capability information of user equipment shown in FIG. 3 is performed by a base station 20, and includes the following operations.

Operation 310. The base station 20 receives air interface indication information sent by UE 10, where the air interface indication information is determined by the UE 10 based on target air interface types, and the target air interface types include at least two air interface types supported by the UE 10 on a same carrier.

Operation 320. The base station 20 schedules the UE 10 based on the air interface indication information.

Therefore, by using the method described in this embodiment of this application, the UE 10 may support different air interface types to use a radio resource on a same cell by in a frequency division manner. Therefore, the capability information of the UE 10 may be flexibly allocated between a plurality of air interface types, so that the UE 10 may more flexibly adapt to dynamic requirements of a service and a radio condition.

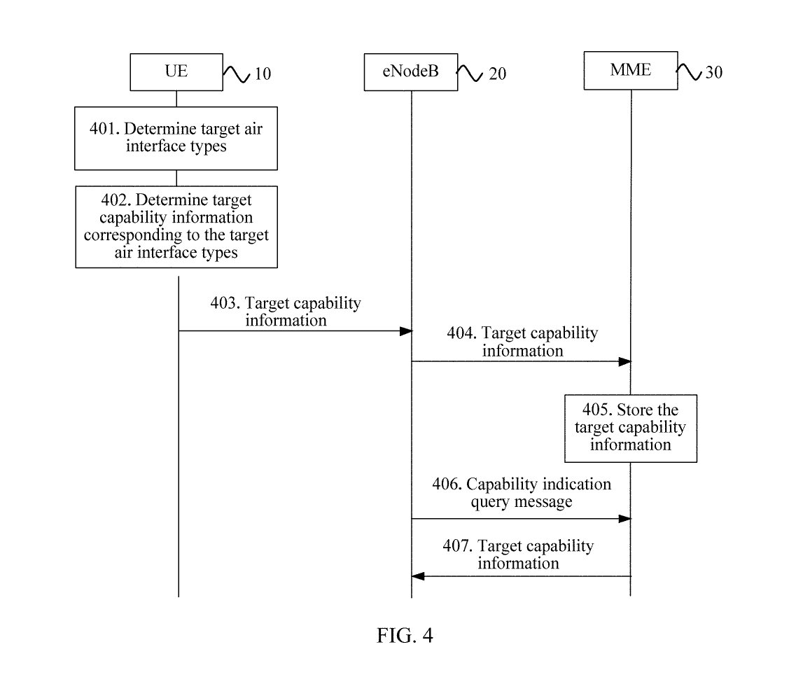

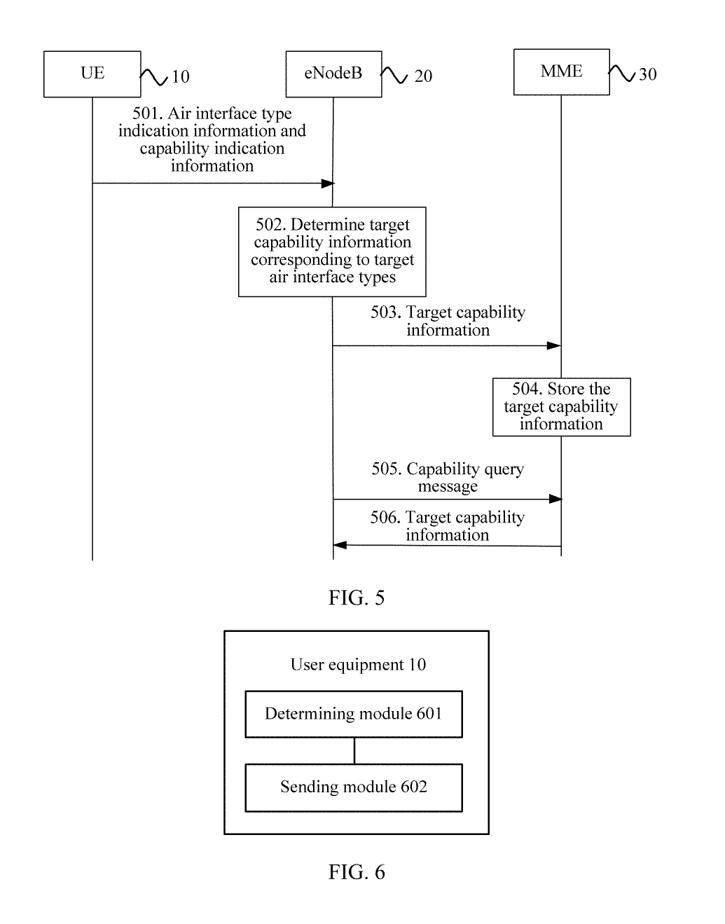

Based on the method for processing capability information of user equipment in FIG. 2 or FIG. 3, for more detailed embodiments, refer to the following descriptions in FIG. 4 and FIG. 5.

FIG. 4 is a process interaction diagram of a method for processing capability information of user equipment according to an embodiment of this application. FIG. 4 shows UE 10, a macro eNodeB 20, and a mobility management entity (“MME” for short) 30. The macro eNodeB 20 is briefly referred to as a base station (eNodeB) 20 below. The UE 10 supports a plurality of air interface types on a same carrier, and different air interface types correspond to different radio interface technologies. As shown in FIG. 4, a specific process of the method for processing capability information of user equipment is as follows:

Operation 401. The UE 10 determines target air interface types.

The target air interface types include at least two air interface types, and the at least two air interface types are located on a same carrier.

For example, if M air interface types are supported on a same carrier of the UE 10, in operation 401, N of the M air interface types may be determined as target air interface types, where M≥2, and 2≤N≤M.

It should be understood that, an air interface type of the UE 10 may be determined based on at least one of the following parameters: a multiple access manner, a frame structure, a cyclic prefix (“CP” for short) length, a hybrid automatic repeat request (“HARQ” for short) round trip time (“RTT” for short), a subcarrier width, and a physical channel, and an uplink subframe configuration, a downlink subframe configuration, and the like are further included for a TDD system. That is, the air interface type may be indicated by a combination of the foregoing parameters, and different air interface types are different in at least one of the foregoing parameters. It should be further understood that, this embodiment of this application includes, but is not limited to, the foregoing parameters, and may further include, for example, a physical layer parameter, a radio frequency parameter, a packet aggregation protocol layer parameter, a Radio Link Control layer parameter, and a duplex mode.

It should be further understood that, the air interface type may be identified by using an air interface name, identification information, and the like. For example, air interface index information is used as identification information.

The multiple access manner may include an orthogonal frequency division multiple access (Orthogonal Frequency Division Multiple Access, “OFDMA” for short) manner, a sparse code multiple access (Sparse Code Multiple Access, “SCMA” for short) manner, and the like. The frame structure may include a supported minimum TTI length that is 0.1 ms, 0.2 ms, or the like, and a supported maximum TTI length that is 1 ms, 2 ms, or the like. The subcarrier width may include a minimum subcarrier width that is 7.5 KHz, 15 KHz, or the like, and a maximum subcarrier width that is 150 KHz, 300 KHz, or the like.

To simplify the description, two air interface types (that is, N=2) are used herein as an example, and the two air interface types respectively use different radio interface technologies. For example, an OFDM modulation technology may be used as either of two radio interface technologies, where one radio interface technology is optimized for a massive-connection M2M service, for example, a sparse code multiple access (Sparse Code Multiple Access, “SCMA” for short) technology is introduced, and an LTE radio interface technology is used as the other radio interface technology. In the SCMA technology, by performing non-orthogonal spreading and superposition in code domain, in a case of a same resource quantity, more service users are accommodated, so that a total throughput of a network is increased under the premise that user experience is not affected. Similar to CDMA, in SCMA, an information transmission rate of a multi-carrier system is increased in a code word spreading manner in frequency domain, that is, a plurality of code words are allowed to be superposed on one system resource block and transmitted.

For another example, in the two radio interface technologies, one radio interface technology is optimized for an ultra-low delay M2M service having a frame structure different from that used for LTE. For example, a frame structure having a subframe (subframe) length of 0.1 ms can be used, and where a subframe length of an LTE frame structure is 1 ms. An LTE radio interface technology can be used as the other radio interface technology.

For another example, in the two radio interface technologies, two radio interfaces use a same frame structure, but HARQ RTTs of the two radio interfaces may be different. For example, a HARQ RTT of one of the radio interface technologies is four TTIs, and a HARQ RTT of the other radio interface is eight TTIs.

For another example, the two radio interface technologies are respectively a radio interface technology used for a unicast service and a radio interface technology used for an MBMS service in conventional LTE radio interface technologies. To resolve interference between frequency ranges that is caused by frequency division of different radio interface technologies, a filtering technology may be used at different frequency ranges, for example, a conventional technology such as filtered OFDM, filter band multi-carrier (“FBMC” for short), or generalized frequency division multiplexing (“GFDM” for short).

Operation 402. The UE 10 determines target capability information corresponding to the target air interface types.

For example, in operation 402, at least two pieces of capability information in a one-to-one correspondence with the at least two air interface types are determined. That is, the target capability information is the at least two pieces of capability information in the one-to-one correspondence with the at least two air interface types included in the target air interface types, and the target air interface types are in a one-to-one correspondence with the target capability information.

In another embodiment, the UE 10 determines the target capability information corresponding to the target air interface types based on a maximum quantity of air interface types that the UE 10 is capable of simultaneously configuring or simultaneously running and a total capability information value of the UE 10.

The total capability information value of the UE 10 is a sum of capability information corresponding to all of the air interface types that the UE 10 can simultaneously configure or run, and the sum of the capability information may indicate a maximum capability information value that the UE 10 can support, for example, a maximum bandwidth that the UE 10 can provide to these air interface types, a maximum spatial multiplexing layer quantity that the UE 10 can support, or a maximum transmit power that the UE 10 can have.

A quantity of the target air interface types is less than or equal to the maximum quantity of air interface types that the UE 10 is capable of simultaneously configuring or simultaneously running.

For example, if the maximum quantity of air interface types that the UE is capable of simultaneously configuring or simultaneously running is P, N≤P should be satisfied. Moreover, usually, P≤M. For example, M=10, P=3, and N=2. This should not be construed as limiting in this application.

It should be understood that, the capability information mentioned herein includes any one of the following: a total quantity of uplink or downlink transport block bits within each TTI, a quantity of uplink or downlink spatial multiplexing layers of the UE 10, a quantity of soft channel bits of the UE 10 within each TTI, a maximum modulation order supported by the UE 10, a total layer 2 buffer size of the UE 10, a physical layer parameter, a radio frequency parameter, and a maximum transmit power of the UE 10. This embodiment of this application includes, but is not limited to, the foregoing parameters.

It should be noted that, the sum of the capability information corresponding to all of the air interface types supported by the UE 10 may exceed the total capability information value of the UE 10, but a sum of capability information corresponding to all of air interface types that the UE 10 simultaneously configures or simultaneously runs within a TTI cannot exceed the total capability information value of the UE 10. When the UE 10 configures or runs only one air interface type, the air interface type exclusively occupies the total capability information value.

It should be further noted that, in some embodiments, the maximum quantity of air interface types that the UE 10 simultaneously configures or simultaneously runs does not exceed a quantity of all air interface types supported by the UE.

For example, the UE 10 may allocate, to each air interface type based on a total quantity of layers that can be multiplexed in uplink or downlink space, a quantity of uplink or downlink spatial multiplexing layers possessed by each air interface type; and the UE 10 may further allocate, to each air interface type based on the maximum modulation order that the UE 10 can support, a maximum modulation order that can be used by each air interface type.

For another example, the UE 10 may further allocate physical layer parameter information to each air interface type of the target air interface types, that is, downlink and uplink multi-input multi-output capability information supported by the UE 10. When the UE 10 simultaneously configures or simultaneously runs a plurality of air interface types, the downlink and uplink multi-input multi-output capability information indicates a sum of maximum spatial multiplexing layer quantities supported by the plurality of air interface types on a frequency band, or indicates a maximum spatial multiplexing layer quantity supported by any air interface type.

For another example, the UE 10 may further allocate radio frequency parameter information to each air interface type of the target air interface types, that is, frequency band combination information supported by the UE 10. When the UE 10 simultaneously configures or simultaneously runs a plurality of air interface types, it indicates frequency bands supported by the plurality of air interface types and combination information of maximum spatial multiplexing layer quantities supported by the plurality of air interface types, or indicates a frequency band supported by one of the air interface types and combination information of a maximum spatial multiplexing layer quantity supported by the one of the air interface types.

In another embodiment, the UE 10 may averagely allocate the total capability information value of the UE 10 based on the maximum quantity of air interface types that the UE 10 is capable of simultaneously configuring or simultaneously running, and determine a capability information value obtained after the average allocation as the target capability information corresponding to each air interface type of the target air interface types.

For example, if a total capability information value of the UE 10 is 1 and a maximum quantity of air interface types that the UE 10 is capable of simultaneously configuring or simultaneously running is 4, a capability information value obtained after the average allocation is 0.25, and therefore 0.25 is used as capability information of each air interface type of the target air interface types. If capability information allocated by the UE 10 to the target air interface types is maximum transmit power information, a transmit power allocated by the UE 10 on each air interface type of the target air interface types accounts for 0.25.

In another embodiment, the UE 10 may further allocate corresponding target capability information to each air interface type of the target air interface types based on the maximum quantity of air interface types that the UE 10 is capable of simultaneously configuring or simultaneously running, the total capability information value of the UE 10, and at least one of the following information:

adaptive change information of each air interface type, a radio resource occupied by each air interface type within each transmission time interval TTI, and a capability requirement value of each air interface type.

The adaptive change information is used to indicate whether each air interface type supports a dynamic capability information configuration and/or a semi-static capability information configuration.

For example, if a total capability information value of the UE 10 is 1 and a maximum quantity of air interface types that the UE 10 is capable of simultaneously configuring or simultaneously running is 3, it may be set that when an air interface type of the UE 10 supports the dynamic capability information configuration, capability information allocated by the UE 10 to the air interface type is 0.5; when an air interface type of the UE 10 supports the semi-static capability information configuration, capability information allocated by the UE 10 to the air interface type is 0.2; or when an air interface type of the UE 10 supports both the dynamic capability information configuration and the semi-static capability information configuration, capability information allocated by the UE 10 to the air interface type is 0.3. Therefore, the UE 10 may allocate corresponding target capability information to each air interface type based on the adaptive change information of each air interface type of the target air interface types.

For another example, the UE 10 may also allocate a total quantity of uplink or downlink transport block bits within each TTI to each air interface type based on a bandwidth occupied by each air interface type of the target air interface types; the UE 10 may further allocate a quantity of soft channel bits within each TTI to each air interface type based on a bandwidth occupied by each air interface type; and the UE 10 may further allocate a total layer 2 buffer size to each air interface type based on a bandwidth occupied by each air interface type.

For another example, the UE 10 may further consider a capability requirement value of each air interface type, and the capability requirement value indicates an inherent requirement of the target air interface types on the capability. Different air interface types may have different requirements for different capability information. Therefore, for a piece of capability information, if a target air interface has a relatively high requirement on the capability information, a relatively high proportion of the capability information of a total capability information value of the capability may be allocated to the target air interface; or if a target air interface has a relatively low requirement on the capability information, a slightly low proportion of the capability information of a total capability information value of the capability may be allocated to the target air interface.

In another embodiment, the UE 10 may determine, based on a quantity of target air interface types determined each time, and a total capability information value of the UE 10, target capability information corresponding to the target air interface types. Therefore, when the target air interface types are changed, the UE 10 needs to flexibly adjust capability information corresponding to the target air interface types.

In another embodiment, based on the method for processing capability information of the UE 10 described in this embodiment of this application, before the UE 10 determines the target air interface types and the capability information corresponding to the target air interface types, air interface types supported by the UE 10 may be further categorized based on parameters included in the capability information. For example, air interface types supporting an orthogonal frequency division multiple access technology are used as a category, air interface types supporting a sparse code multiple access technology are used as a category, and then each category of air interface types is operated in the foregoing manner. Therefore, it is convenient for the UE 10 to search for and determine a target air interface type.

In another embodiment, the target air interface types sent by the UE 10 to the base station 20 may be sent based on an indication of the base station 20. For example, the base station 20 may send capability query information to the UE 10, and the capability query information is used to instruct the UE 10 to send the target air interface types. For example, the base station 20 may be designated to obtain capability information corresponding to a first air interface type and a second air interface type from the UE 10, or capability information corresponding to all air interface types supported by the UE 10.

Additionally, although the UE 10 supports a plurality of air interface types on a same carrier, a quantity of the target air interface types sent by the UE 10 to the base station 20 may be at least two of the plurality of air interface types or one of the plurality of air interface types. For example, when there is only one air interface type that the UE 10 is about to run, capability information corresponding to only the air interface type may be sent to the base station 20. This should not be construed as limiting in this application.

In another embodiment, the UE 10 may not allocate capability information to the target air interface types based on a maximum quantity of air interface types that can be simultaneously configured or simultaneously run, but instead, capability information corresponding to each air interface type is defined for each air interface type of the target air interface types based on a parameter characteristic of each air interface type of the target air interface types, costs of the UE 10, a network condition, and the like. For example, the UE 10 defines a maximum downlink or uplink transport block bit quantity within each TTI for each air interface type of the target air interface types; the UE 10 defines a maximum downlink spatial multiplexing layer quantity for each air interface type of the target air interface types; the UE 10 defines a quantity of soft channel bits within each TTI for each air interface type of the target air interface types; the UE 10 defines a maximum layer 2 buffer size for each air interface type of the target air interface types; or the UE 10 defines define maximum transmit power information of the UE 10 and the like for each air interface type of the target air interface types.

It should be noted that, the sum of the capability information of all of the air interface types supported by the UE 10 may exceed the total capability information value of the UE 10, but it needs to be ensured that a sum of capability information corresponding to all of air interface types that the UE 10 simultaneously configures or simultaneously runs within a TTI cannot exceed the total capability information value of the UE 10.

Operation 403. The UE 10 sends the target capability information corresponding to the target air interface types to the base station 20.

For example, the UE 10 may send target capability information corresponding to each air interface type of the determined target air interface types to the base station 20, so that the base station 20 schedules the UE 10 based on the target capability information. The scheduling, by the base station 20, the UE 10 may include flexibly allocating, by the base station 20, a radio resource to the UE 10 between a plurality of air interfaces.

In another embodiment, after operation 403, the method may further include operations 404 and 405.

Operation 404. The base station 20 sends the target capability information corresponding to the target air interface types to the MME 30.

For example, the base station 20 may further send the target capability information corresponding to the target air interface types to the MME 30, so that the MME 30 stores the target capability information performing, and subsequently the base station 20 may directly obtain capability information corresponding to each air interface type from the MME 30, that is, may obtain the target capability information corresponding to the target air interface types by performing operations 406 and 407.

It should be noted that, the base station 20 may send the target capability information corresponding to the target air interface types to at least two mobility management entities. The at least two MMEs are in a one-to-one correspondence with the at least two target air interface types. The MME 30 included in a plurality of MMEs is used as an example herein to perform description.

Operation 405. The MME 30 stores the target capability information corresponding to the target air interface types.

For example, after receiving a capability indication information of the UE 10, the base station 20 may further respectively send the target capability information corresponding to the target air interface types of the UE 10 to different mobility management entities for storage. Using the MME 30 as an example, the base station 20 may directly obtain the target capability information of the target air interface types corresponding to the UE 10 from the MME 30 by sending capability query information to the MME 30, that is, may perform operations 406 and 407; If the MME 30 does not store the target capability information of the target air interface types requested by the base station 20, the base station 20 obtains the target capability information of the target air interface types of the UE 10 from the UE 10 again, and notifies the target capability information to the MME 30 for storage.

That is, for different air interface types, the UE 10 establishes services by using different mobility management entities, the base station 20 stores a mapping relationship between an air interface type and a mobility management entity, and when needing capability information of a corresponding air interface type, the base station 20 may respectively obtain corresponding capability information of the UE 10 from different mobility management entities.

Operation 406. The base station 20 sends a capability query message to the MME 30.

The capability query message is used to query the target capability information corresponding to the target air interface types.

For example, after receiving the target capability information corresponding to the target air interface types sent by the UE 10, the base station 20 may further respectively send the target capability information to different mobility management entities for storage. Using the MME 30 as an example, the base station 20 may directly obtain the target capability information of the target air interface types corresponding to the UE 10 from the MME 30 by sending capability query information to the MME 30. If the MME 30 does not store the target capability information corresponding to the target air interface types requested by the base station 20, the base station 20 determines the target capability information corresponding to the target air interface types again.

Operation 407. The base station 20 receives the target capability information corresponding to the target air interface types sent by the MME 30.

For example, when the UE 10 needs to configure or run the target air interface types, the UE 10 accesses the base station 20 from a Radio Resource Control (Radio Resource Control, “RRC” for short) idle (idle) state, the UE 10 performs a Radio Resource Control connection re-establishment (RRC connection re-establishment) process to access the base station 20, or the UE 10 performs handover (handover) to the base station 20, the base station 20 may directly obtain the target capability information corresponding to the target air interface types from the MME 30.

Therefore, by using the method described for some embodiments of this application, different air interface types supported by the UE 10 use a radio resource on a same cell in a frequency division manner, the UE may independently determine target capability information, and the base station 20 may obtain capability information corresponding to the different air interface types supported by the UE 10, thereby flexibly allocating a resource to the UE 10 between a plurality of air interface types based on the capability information of the UE 10, so as to more flexibly adapt to dynamic requirements of a service and a radio condition.

A process in which the UE 10 determines the target capability information corresponding to the target air interface types is described above, and a process in which the base station 20 determines the target capability information corresponding to the target air interface types is described below with reference to FIG. 5. The UE 10 may also notify information about a target air interface type to the base station 20, and the base station 20 allocates corresponding target capability information to the target air interface type, thereby properly scheduling the UE based on the target capability information corresponding to the target air interface type.

FIG. 5 is a process interaction diagram of a method for processing capability information of user equipment according to another embodiment of this application. FIG. 5 shows UE 10, an eNodeB 20, and an MME 30. The UE 10 supports a plurality of air interface types on a same carrier, and different air interface types correspond to different radio interface technologies. As shown in FIG. 5, a process of the method for processing capability information of user equipment is as follows:

Operation 501. The UE 10 sends target air interface type indication information and capability indication information to the base station 20.

For example, the UE 10 determines at least two of a plurality of air interface types supported on a same carrier as target air interface types, and sends, to the base station 20, the target air interface type indication information used to indicate the target air interface types.

For example, if M air interface types are supported on a same carrier of the UE 10, the UE 10 may determine N of the M air interface types as target air interface types, where M≥2, and 2≤N≤M.

In another embodiment, the UE 10 determines, based on a to-be-processed service, target air interface types to be configured or run, and sends information related to the target air interface types to the base station 20. The base station 20 receives the target air interface types sent by the UE 10, and receives capability indication information sent by the UE, where the capability indication information is used to indicate a maximum quantity of air interface types that the UE 10 is capable of simultaneously configuring or simultaneously running, and a total capability information value of the UE 10.

It should be understood that, in 501, the target air interface types and the capability indication information may be simultaneously sent, or the UE 10 may first send the target air interface types to the base station 20 and then send the capability indication information. This should not be construed as limiting in this application.

Operation 502. The base station 20 determines target capability information corresponding to the target air interface types.

For example, in operation 502, the base station 20 determines at least two pieces of capability information in a one-to-one correspondence with the at least two air interface types. That is, the at least two pieces of capability information are the target capability information, and the target capability information corresponds to the target air interface types.

In another embodiment, after receiving the target air interface types and the capability indication information that are sent by the UE 10, the base station 20 may determine, based on the maximum quantity of air interface types that the UE 10 is capable of simultaneously configuring or simultaneously running, and the total capability information value of the UE 10, the target capability information corresponding to the target air interface types.

A quantity of the target air interface types is less than or equal to the maximum quantity of air interface types that the UE 10 is capable of simultaneously configuring or simultaneously running.

For example, if the maximum quantity of air interface types that the UE is capable of simultaneously configuring or simultaneously running is P, N≤P should be satisfied. Moreover, usually, P≤M. For example, M=10, P=3, and N=2. This is not limited in this application.

It should be noted that, the sum of the capability information corresponding to all of the air interface types supported by the UE 10 may exceed the total capability information value of the UE 10, but a sum of capability information corresponding to all of air interface types that the UE 10 simultaneously configures or simultaneously runs within a TTI cannot exceed the total capability information value of the UE 10. When the UE 10 configures or runs only one air interface type, the air interface type exclusively occupies the total capability information value.

It should be further noted that, the maximum quantity of air interface types that the UE 10 simultaneously configures or simultaneously runs does not exceed a quantity of all air interface types supported by the UE.

In another embodiment, the base station 20 may averagely allocate the total capability information value of the UE 10 based on the maximum quantity of air interface types that the UE 10 is capable of simultaneously configuring or simultaneously running, and determine a capability information value obtained after the average allocation as the target capability information corresponding to each air interface type of the target air interface types.

In another embodiment, the base station 20 may further allocate corresponding target capability information to each air interface type of the target air interface types based on the maximum quantity of air interface types that the UE 10 is capable of simultaneously configuring or simultaneously running, the total capability information value of the UE 10, and at least one of the following information:

adaptive change information of each air interface type, a radio resource occupied by each air interface type within each transmission time interval TTI, and a capability requirement value of each air interface type.

The adaptive change information can be used to indicate whether each air interface type supports a dynamic capability information configuration and/or a semi-static capability information configuration.

In another embodiment, the base station 20 may determine, based on a quantity of target air interface types determined by the UE 10 each time, and a total capability information value of the UE 10, target capability information corresponding to the target air interface types. Therefore, when the target air interface types are changed, the UE 10 needs to flexibly adjust capability information corresponding to the target air interface types.

It should be understood that, the target air interface types sent by the UE 10 to the base station 20 may be sent based on an indication of the base station 20. For example, the base station 20 may be designated to obtain capability information corresponding to a first air interface type and a second air interface type that are, or capability information corresponding to all air interface types supported by the UE 10.

Additionally, although the UE 10 supports a plurality of air interface types on a same carrier, there may be one or more target air interface types sent by the UE 10 to the base station 20. For example, when there is only one air interface type that the UE 10 is about to run, information about only the air interface type may be sent to the base station 20. This is not limited in this application.

In another embodiment, the base station 20 may not allocate capability information to the target air interface types based on a maximum quantity of air interface types that can be simultaneously configured or simultaneously run, but instead, capability information corresponding to each air interface type is defined for each air interface type of the target air interface types based on a parameter characteristic of each air interface type of the target air interface types, costs of the UE 10, a network condition, and the like.

It should be noted that, the sum of the capability information of all of the air interface types supported by the UE 10 may exceed the total capability information value of the UE 10, but it needs to be ensured that a sum of capability information corresponding to all of air interface types that the UE 10 simultaneously runs within a TTI cannot exceed the total capability information value of the UE 10.

In one embodiment, after operation 502, the method may further include operations 503 and 504. For details, refer to FIG. 5. For specific descriptions of operations 503 to 506 in FIG. 5, refer to operations 404 to 407 in FIG. 4. For brevity, details are not described herein again.

Therefore, in the method described in this embodiment of this application, capability information of a flexible air interface can be introduced, and a problem that a radio resource use manner cannot flexibly adapt to dynamic requirements of a service and a radio condition is resolved. The base station 20 determines the target capability information of the UE 10, so that the UE 10 can support a plurality of different air interface types on a same carrier. Therefore, the base station 20 may flexibly allocate a resource to the UE 10 between a plurality of air interface types based on the capability information of the UE 10 more flexibly, so as to more flexibly adapt to dynamic requirements of a service and a radio condition.

It should be understood that, sequence numbers of the foregoing processes do not indicate an execution sequence, and an execution sequence of processes shall be determined based on functions and internal logic thereof, and shall constitute no limitation on an implementation process of the embodiments of this application.

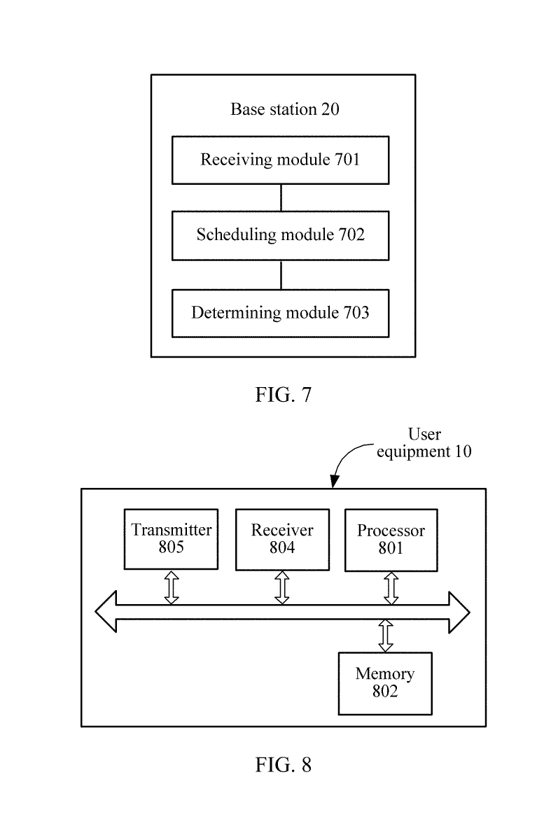

The forbidding methods according to the embodiments of this application are described in detail above with reference to FIG. 2 to FIG. 5, and user equipment 10 and a base station 20 according to the embodiments of this application are described in detail below with reference to FIG. 6 and FIG. 7.

FIG. 6 is a structural block diagram of user equipment 10 according to an embodiment of this application. As shown in FIG. 6, the user equipment 10 includes a determining module 601 and a sending module 602.

The determining module 601 is configured to determine at least two of a plurality of air interface types supported by a same carrier as target air interface types.

The sending module 602 is configured to send air interface indication information to a base station 20 based on the target air interface types determined by the determining module 601, so that the base station schedules the UE 10 based on the target capability information.

In another embodiment, the air interface indication information includes target capability information corresponding to the target air interface types, and the target capability information is at least two pieces of capability information in a one-to-one correspondence with the at least two air interface types.

Before the UE sends the air interface indication information to the base station, the determining module 601 is further configured to:

determine the target capability information.

Therefore, the user equipment 10 described in this embodiment of this application supports different air interface types to use a radio resource on a same cell by in a frequency division manner, and the UE 10 determines capability information corresponding to the different air interface types, so that the base station 20 may flexibly allocate a resource to the UE 10 between a plurality of air interface types based on the capability information, so as to more flexibly adapt to dynamic requirements of a service and a radio condition.

In another embodiment, the determining module 601 is configured to:

determine the target capability information corresponding to the target air interface types based on a maximum quantity of air interface types that the UE 10 is capable of simultaneously configuring or simultaneously running and a total capability information value of the UE 10, where a quantity of the target air interface types is less than or equal to the maximum quantity of air interface types that the UE 10 is capable of simultaneously configuring or simultaneously running.

In another embodiment, the determining module 601 is configured to:

averagely allocate the total capability information value based on the maximum quantity of air interface types that the UE 10 is capable of simultaneously configuring or simultaneously running, and determining a capability information value obtained after the average allocation as the target capability information corresponding to the target air interface types.

In another embodiment, the determining module 601 is configured to:

determine the target capability information based on the maximum quantity of air interface types that the UE 10 is capable of simultaneously configuring or simultaneously running, the total capability information value of the UE 10, and at least one of the following information:

adaptive change information of the target air interface types, radio resources occupied by the target air interface types within each transmission time interval TTI, and capability requirement values of the target air interface types, where the adaptive change information is used to indicate whether the target air interface types support a dynamic capability information configuration and/or a semi-static capability information configuration.

FIG. 7 is a structural block diagram of a base station 20 according to an embodiment of this application. As shown in FIG. 7, the base station 20 includes a receiving module 701 and a scheduling module 702.

The receiving module 701 is configured to receive air interface indication information sent by the UE 10, where the air interface indication information is determined by the UE 10 based on target air interface types, and the target air interface types include at least two of a plurality of air interface types supported by the UE on a same carrier.

The scheduling module 702 is configured to schedule the UE based on the air interface indication information received by the receiving module 701.

In another embodiment, the air interface indication information includes the target air interface types determined by the UE 10, the base station 20 further includes a determining module 703, and the determining module 703 is configured to:

determine target capability information corresponding to the target air interface types, where the target capability information is at least two pieces of capability information in a one-to-one correspondence with the at least two air interface types.

The scheduling module 702 is further configured to:

schedule the UE 10 based on the target capability information determined by the determining module 703.

Therefore, different air interface types supported by the UE 10 use a radio resource on a same cell by in a frequency division manner, and by determining capability information corresponding to the different air interface types supported by the UE 10, the base station 20 may flexibly allocate a resource to the UE 10 between a plurality of air interface types based on the capability information of the UE 10, so as to more flexibly adapt to dynamic requirements of a service and a radio condition.

In another embodiment, the receiving module 701 is further configured to:

receive capability indication information sent by the UE 10, where the capability indication information includes a maximum quantity of air interface types that the UE 10 is capable of simultaneously configuring or simultaneously running, and a total capability information value of the UE 10.

The determining module 703 is configured to:

determine the target capability information corresponding to the target air interface types based on a maximum quantity of air interface types that the UE 10 is capable of simultaneously configuring or simultaneously running and a total capability information value of the UE 10, where a quantity of the target air interface types is less than or equal to the maximum quantity of air interface types that the UE 10 is capable of simultaneously configuring or simultaneously running.

In another embodiment, the determining module 703 is further configured to:

averagely allocate the total capability information value based on the maximum quantity of air interface types that the UE 10 is capable of simultaneously configuring or simultaneously running, and determining a capability information value obtained after the average allocation as the target capability information corresponding to the target air interface types.

In another embodiment, the determining module 703 is further configured to:

determine the target capability information corresponding to the target air interface types based on the maximum quantity of air interface types that the UE 10 is capable of simultaneously configuring or simultaneously running, the total capability information value of the UE 10, and at least one of the following information:

adaptive change information of the target air interface types, radio resources occupied by the target air interface types within each transmission time interval TTI, and capability requirement values of the target air interface types, where the adaptive change information is used to indicate whether the target air interface types support a dynamic capability information configuration and/or a semi-static capability information configuration.

As shown in FIG. 8, an embodiment of this application further provides user equipment 10. The user equipment 10 includes a processor 801, a memory 802, a receiver 804, and a transmitter 805. The processor 801, the memory 802, and the receiver 804 communicate with each other by using an internal connection path, so as to transmit a control signal and/or data, the memory 802 is configured to store an instruction, and the processor 801 is configured to execute the instruction stored in the memory 802, and control the receiver 804 to receive information. The processor 801, the memory 802, the receiver 804, and the transmitter 805 may be implemented by using one or more chips. For example, the processor 801, the memory 802, the receiver 804, and the transmitter 805 may all be integrated into one chip. Alternatively, the processor 801, the receiver 804, and the transmitter 805 may be integrated into one chip, and the memory 802 is integrated into another chip. A specific form should not be construed as limiting herein. The processor 801 is configured to:

determine at least two of a plurality of air interface types supported by a same carrier as target air interface types.

The transmitter 805 is configured to send air interface indication information to a base station 20 based on the target air interface types, so that the base station 20 schedules the UE 10 based on the air interface indication information.

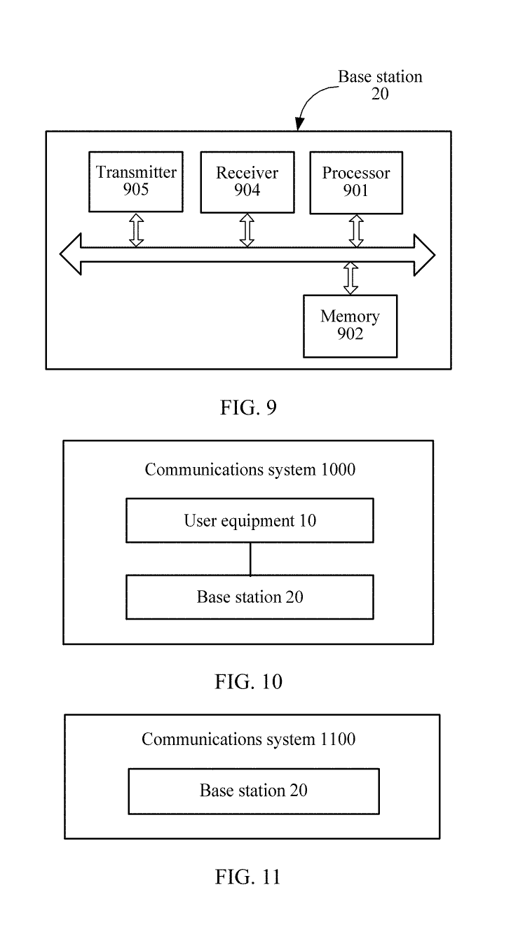

As shown in FIG. 9, an embodiment of this application further provides a base station 20. The base station 20 includes a processor 901, a memory 902, a receiver 904, and a transmitter 905. The processor 901, the memory 902, and the receiver 904 communicate with each other by using an internal connection path, so as to transmit a control signal and/or data, the memory 902 is configured to store an instruction, and the processor 901 is configured to execute the instruction stored in the memory 902, and control the receiver 904 to receive information. The processor 901, the memory 902, the receiver 904, and the transmitter 905 may be implemented by using one or more chips. For example, the processor 901, the memory 902, the receiver 904, and the transmitter 905 may all be integrated into one chip. Alternatively, the processor 901, the receiver 904, and the transmitter 905 may be integrated into one chip, and the memory 902 is integrated into another chip. A specific form should not be construed as limiting herein. The receiver 904 is configured to:

receive air interface indication information sent by UE 10, where the air interface indication information is determined by the UE 10 based on target air interface types, and the target air interface types include at least two of a plurality of air interface types supported by the UE 10 on a same carrier.

The processor 901 schedules the UE 10 based on the air interface indication information.

FIG. 10 is a schematic structural diagram of a communications system according to an embodiment of this application. The communications system 1000 shown in FIG. 10 includes user equipment 10 and a base station 20.

FIG. 11 is a schematic structural diagram of a communications system according to an embodiment of this application. The communications system 1100 shown in FIG. 11 includes a base station 20.

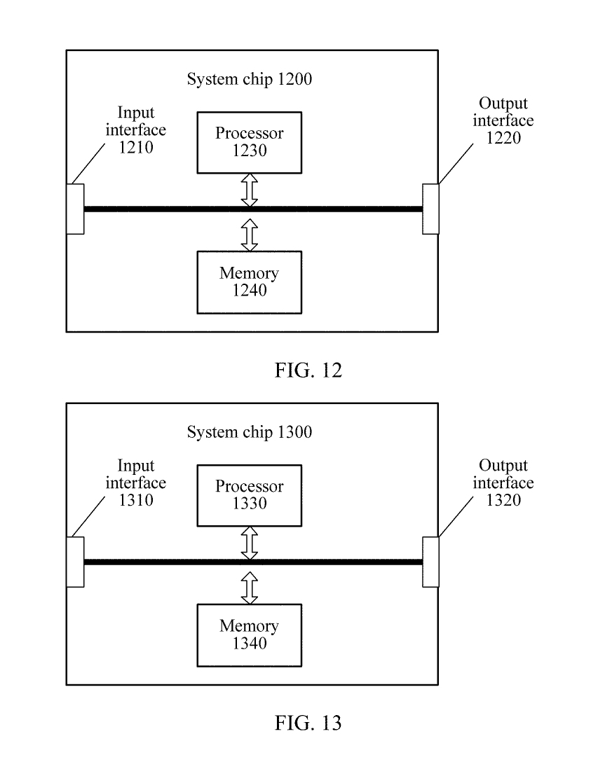

FIG. 12 is a schematic structural diagram of a system chip according to an embodiment of this application. The system chip 1200 shown in FIG. 12 includes an input interface 1210, an output interface 1220, at least one processor 1230, and a memory 1240. The input interface 1210, the output interface 1220, the processor 1230, and the memory 1240 communicate with each other by using an internal connection path, the processor 1230 is configured to execute code in the memory 1240, and when the code is executed, the processor 1230 implements a method performed by the user equipment 10 in FIG. 2 to FIG. 5. The input interface 1210 and the output interface 1220 may alternatively be a same interface, and the interface may implement both a function of the input interface 1210 and a function of the output interface 1220.

FIG. 13 is a schematic structural diagram of a system chip according to an embodiment of this application. The system chip 1300 shown in FIG. 13 includes an input interface 1310, an output interface 1320, at least one processor 1330, and a memory 1340. The input interface 1310, the output interface 1320, the processor 1330, and the memory 1340 communicate with each other by using an internal connection path, the processor 1330 is configured to execute code in the memory 1340, and when the code is executed, the processor 1330 may implement a method performed by the base station 20 in FIG. 2 to FIG. 5. The input interface 1310 and the output interface 1320 may alternatively be a same interface, and the interface may implement both a function of the input interface 1310 and a function of the output interface 1320.

It may be understood by a person skilled in the art that, for the purpose of convenient and brief description, for a detailed working process of the foregoing system, apparatus, and unit, refer to a corresponding process in the foregoing method embodiments, and details are not described herein again.

The memory in the embodiments of the present invention may be a volatile memory or a nonvolatile memory, or may include a volatile memory and a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The memory of the systems and methods described in this specification includes but is not limited to these and any memory of another proper type.

A person of ordinary skill in the art may be aware that, in combination with the examples described in the embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the operations of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

1. A method for processing capability information of a mobile device, wherein the method comprises:
determining, by a mobile device, at least two of a plurality of air interface types supported by a same carrier as target air interface types; and
sending, by the mobile device, air interface indication information to a base station based on the target air interface types, so that the base station schedules the mobile device based on the air interface indication information.

2. The method according to claim 1, wherein the air interface indication information comprises target capability information corresponding to the target air interface types, and the target capability information includes at least two pieces of capability information in a one-to-one correspondence with the at least two air interface types, and the method further comprises:
determining, by the mobile device, the target capability information.

3. The method according to claim 2, wherein the determining, by the mobile device, the target capability information comprises:
determining, by the mobile device, the target capability information based on a maximum quantity of air interface types that the mobile device is capable of simultaneously configuring or simultaneously running and a total capability information value of the mobile device, wherein a quantity of the target air interface types is less than or equal to the maximum quantity of air interface types that the mobile device is capable of simultaneously configuring or simultaneously running.

4. The method according to claim 3, wherein the determining, by the mobile device, the target capability information based on a maximum quantity of air interface types that the mobile device is capable of simultaneously configuring or simultaneously running and a total capability information value of the mobile device comprises:
determining, by the mobile device, the target capability information based on the maximum quantity of air interface types that the mobile device is capable of simultaneously configuring or simultaneously running, the total capability information value of the mobile device, and at least one of the following information:
adaptive change information of the target air interface types, radio resources occupied by the target air interface types within each transmission time interval TTI, and capability requirement values of the target air interface types, wherein the adaptive change information is used to indicate whether the target air interface types support a dynamic capability information configuration and/or a semi-static capability information configuration.

5. The method according to claim 2, wherein the target capability information comprises at least one of the following:
a total quantity of uplink or downlink transport block bits within each TTI, a quantity of uplink or downlink spatial multiplexing layers of the mobile device, a quantity of soft channel bits of the mobile device within each TTI, a maximum modulation order supported by the mobile device, a total layer 2 buffer size of the mobile device, a physical layer parameter, a radio frequency parameter, and a maximum transmit power of the mobile device.

6. The method according to claim 1, wherein the air interface indication information comprises indication information used to indicate the target air interface types determined by the mobile device, and the method further comprises:
sending, by the mobile device, capability indication information to the base station, wherein the capability indication information comprises a maximum quantity of air interface types that the mobile device is capable of simultaneously configuring or simultaneously running, and a total capability information value of the mobile device.

7. A mobile device, wherein the mobile device comprises:
a processor, configured to determine at least two of a plurality of air interface types supported by a same carrier as target air interface types; and
a transceiver, configured to send air interface indication information to a base station based on the target air interface types determined by the processor, so that the base station schedules the mobile device based on the air interface indication information.

8. The mobile device according to claim 7, wherein the air interface indication information comprises target capability information corresponding to the target air interface types, and the target capability information includes at least two pieces of capability information in a one-to-one correspondence with the at least two air interface types, and
the processor is further configured to:
determine the target capability information.

9. The mobile device according to claim 8, wherein the processor is configured to:
determine the target capability information based on a maximum quantity of air interface types that the mobile device is capable of simultaneously configuring or simultaneously running and a total capability information value of the mobile device, wherein a quantity of the target air interface types is less than or equal to the maximum quantity of air interface types that the mobile device is capable of simultaneously configuring or simultaneously running.

10. The mobile device according to claim 9, wherein the processor is configured to:
determine the target capability information corresponding to the target air interface types based on the maximum quantity of air interface types that the mobile device is capable of simultaneously configuring or simultaneously running, the total capability information value of the mobile device, and at least one of the following information:
adaptive change information of the target air interface types, radio resources occupied by the target air interface types within each transmission time interval TTI, and capability requirement values of the target air interface types, wherein the adaptive change information is used to indicate whether the target air interface types support a dynamic capability information configuration and/or a semi-static capability information configuration.

11. The mobile device according to claim 7, wherein the air interface indication information comprises indication information used to indicate the target air interface types determined by the mobile device, and the transceiver is further configured to:
send capability indication information to the base station, wherein the capability indication information comprises a maximum quantity of air interface types that the mobile device is capable of simultaneously configuring or simultaneously running, and a total capability information value of the mobile device.

12. A base station, wherein the base station comprises:
a transceiver, configured to receive air interface indication information sent by a mobile device, wherein the air interface indication information is determined by the mobile device based on target air interface types, and the target air interface types comprise at least two of a plurality of air interface types supported by the mobile device on a same carrier; and
a processor, configured to schedule the mobile device based on the air interface indication information received by the transceiver.

13. The base station according to claim 12, wherein the air interface indication information comprises indication information used to indicate the target air interface types determined by the mobile device, wherein the processor is further configured to:
determine target capability information corresponding to the target air interface types, wherein the target capability information includes at least two pieces of capability information in a one-to-one correspondence with the at least two air interface types; and
schedule the mobile device based on the target capability information determined by the processor.

14. The base station according to claim 13, wherein the transceiver is further configured to:
receive capability indication information sent by the mobile device, wherein the capability indication information comprises a maximum quantity of air interface types that the mobile device is capable of simultaneously configuring or simultaneously running, and a total capability information value of the mobile device, wherein
the processor is further configured to:
determine the target capability information corresponding to the target air interface types based on a maximum quantity of air interface types that the mobile device is capable of simultaneously configuring or simultaneously running and a total capability information value of the mobile device, wherein a quantity of the target air interface types is less than or equal to the maximum quantity of air interface types that the mobile device is capable of simultaneously configuring or simultaneously running.

15. The base station according to claim 14, wherein the processor is configured to:
determine the target capability information corresponding to the target air interface types based on the maximum quantity of air interface types that the mobile device is capable of simultaneously configuring or simultaneously running, the total capability information value of the mobile device, and at least one of the following information:
adaptive change information of the target air interface types, radio resources occupied by the target air interface types within each transmission time interval TTI, and capability requirement values of the target air interface types, wherein the adaptive change information is used to indicate whether the target air interface types support a dynamic capability information configuration and/or a semi-static capability information configuration.

16. The base station according to claim 12, wherein the air interface indication information comprises target capability information corresponding to the target air interface types, and the target capability information includes at least two pieces of capability information in a one-to-one correspondence with the at least two air interface types.
